(19) United States
(12) Patent Application Publication
(10) Pub. No.: US 2006/0222232 A1
(43) Pub. Date: Oct. 5, 2006

(54) Appearance inspection apparatus and appearance inspection method

(76) Inventor: Akio Ishikawa, Tokyo (JP)

Correspondence Address: CHRISTIE, PARKER & HALE, LLP, PO BOX 7068, PASADENA, CA, 91109-7068, US

(21) Appl. No.: 11/396,173

(22) Filed: Mar. 30, 2006

(30) Foreign Application Priority Data
Apr. 1, 2005 (JP) 2005-106187

(51) Int. Cl. G06K 9/00

(52) U.S. Cl. 382/141

(57) ABSTRACT

The invention provides an appearance inspection apparatus and an appearance inspection method wherein, in addition to defect information, information indicating differences between images used for inspecting the appearance of samples is reported to the user, thereby making it possible to present the differences between the samples which the user has been unable to know in the prior art appearance inspection. The appearance inspection apparatus comprises: an imaging unit (4) which captures an image of a surface of a sample (3); and a defect detecting unit (5, 6, 7, 8) which detects a defect on the sample (3) based on the image acquired by the imaging unit (4), wherein the appearance inspection apparatus further comprises: a distribution information computing unit (10) which computes distribution information indicating the distribution of pixel values in the image captured by the imaging unit (4); and a distribution information output unit (20) which outputs the distribution information in addition to information concerning the defect detected by the defect detecting unit (5, 6, 7, 8).

### BACKGROUND OF THE INVENTION

1. Field of the Invention

The present invention relates to an appearance inspection apparatus which captures an image of a surface of a sample and inspects the appearance of the sample based on the captured image and, more particularly, to an appearance inspection apparatus for detecting defects on a liquid crystal display panel or in a semiconductor circuit pattern formed on a semiconductor wafer during a semiconductor fabrication process.

2. Description of the Related Art

It is widely practiced to generate image data by capturing an image of a formed pattern and inspect the pattern for a defect, etc. by analyzing the image data. In particular, in the field of semiconductor fabrication, photomask inspection equipment for inspecting photomasks and appearance inspection equipment for inspecting patterns formed on semiconductor wafers or liquid crystal display panels are widely used. The description herein is given by taking as an example an appearance inspection apparatus (inspection machine) for detecting defects in a semiconductor circuit pattern formed on a semiconductor wafer during a semiconductor fabrication process, but the invention is not limited to this particular type of apparatus.

Generally, a bright field inspection apparatus, which illuminates the surface of a sample from a vertical direction and captures the image by reflected light, is employed for this type of appearance inspection apparatus, but a dark field inspection apparatus which does not directly capture the illumination light is also used. In the case of the dark field inspection apparatus, the surface of the sample is illuminated from an oblique or a vertical direction, a sensor is disposed so as not to detect any specularly reflected light, and the dark field image of the surface of the sample is obtained by sequentially scanning the surface with the illumination light. Accordingly, certain types of dark field apparatus may not use image sensors, but it will be appreciated that the present invention is also applicable to such types of apparatus.

In this way, the present invention can be applied to any type of appearance inspection apparatus and method, provided that the apparatus and method are designed to inspect the appearance of a sample based on the image captured from the surface of the sample.

In the semiconductor fabrication process, many chips (dies) are formed on a semiconductor wafer. Patterns are formed in multiple layers on each die. Each completed die is electrically tested using a prober and a tester, and any defective die is eliminated from the assembly process. In the semiconductor fabrication process, the fabrication yield is a very important factor, and the result of the electrical testing is therefore fed back to the fabrication process and used for the management of each process step. However, as the semiconductor fabrication process consists of many process steps, it takes a very long time before the electrical testing can be conducted after the start of the fabrication process; as a result, when, for example, a certain process step is found faulty as a result of the electrical testing, many wafers are already partway through the process, and the result of the electrical testing cannot be properly utilized for improving the yield. In view of this, appearance inspection such as pattern defect inspection is performed to inspect formed patterns in the middle of the process in order to detect defects. If the pattern defect inspection is performed at a plurality of stages in the fabrication process, it becomes possible to detect defects that occurred after the previous inspection, and the result of the inspection can thus be promptly reflected in the process management.

FIG. 1 is a block diagram showing an appearance inspection apparatus that the applicant of this patent application proposed in Japanese Unexamined Patent Publication No. 2004-177397. As shown, a sample holder (chuck stage) 2 is mounted on the upper surface of a stage 1 which is movable in two or three directions. A semiconductor wafer 3 to be inspected is placed on the sample holder and held fixed thereon. An imaging device 4 constructed from a one-dimensional or two-dimensional CCD camera or the like is disposed above the stage, and the imaging device 4 generates an image signal by capturing an image of the pattern formed on the semiconductor wafer 3.

As shown in FIG. 2, a plurality of dies 3a are formed on the semiconductor wafer 3 in a matrix pattern repeating in the X and Y directions. As the same pattern is formed on each die, it is general practice to compare the images of corresponding portions between adjacent dies. If there is no defect in the two adjacent dies, the gray level difference between them is smaller than a threshold value, but if there is a defect in either one of the dies, the gray level difference is larger than the threshold value (single detection). At this stage, however, this is no knowing which die contains the defect; therefore, the die is further compared with a die adjacent on a different side and, if the gray level difference in the same portion is larger than the threshold value, then it is determined that the die under inspection contains the defect (double detection).

The imaging device 4 comprises a one-dimensional CCD camera, and the stage 1 is moved so that the imaging device 4 moves (scans) relative to the semiconductor wafer 3 at a constant speed in the X or Y direction. The image signal is converted into a multi-valued digital signal (gray level signal), which is then supplied to a difference detection unit 6 and also to a signal storage unit 5 for storing therein. As the scanning proceeds, a gray level signal is generated from the adjacent die, in synchronism with which the gray level signal of the preceding die is read out of the signal storage unit 5 and supplied to the difference detection unit 6. Actually, processing such as fine registration is also performed, but a detailed description of such processing will not be given here.

In this way, the gray level signals of the two adjacent dies are input to the difference detection unit 6, which computes the difference (gray level difference) between the two gray level signals and supplies it to a detection threshold value calculation unit 7 and a detection unit 8. Here, the difference detection unit 6 computes the absolute value of the gray level difference and outputs it as the gray level difference. The detection threshold value calculation unit 7 determines the detection threshold value based on the gray level difference, and supplies the detection threshold value to the detection unit 8. The detection unit 8 compares the gray level difference with the thus determined threshold value to determine whether or not the portion under inspection contains a defect.

Generally, the noise level of an image captured from a semiconductor pattern differs depending on the kind of the pattern, for example, whether it is a memory cell portion, a logic circuit portion, a wiring portion, or an analog circuit portion. Correspondence between each of such portions and the kind of the semiconductor pattern can be found from the design data. Therefore, the detection threshold value calculation unit 7 automatically determines the threshold value, for example, for each portion in accordance with the distribution of gray level differences in that portion, and the detection unit 8 makes the determination by using the threshold value determined for each portion.

FIG. 3 is a block diagram showing the prior art configuration example of the detection threshold value calculation unit 7. As shown, the detection threshold value calculation unit 7 comprises: a cumulative frequency computing unit 31 which takes as an input the gray level difference output from the difference detection unit 6, and computes its cumulative frequency; a converted cumulative frequency computing unit 32 which takes the cumulative frequency as an input, and computes a converted cumulative frequency by converting the cumulative frequency so that the cumulative frequency shows a linear relationship to the gray level difference; an approximation straight line computing unit 33 which computes an approximation straight line by approximating the entirety of the converted cumulative frequency by a straight line; and a threshold value determining unit 34 which, based on the approximation straight line, determines the threshold value from a prescribed cumulative frequency value in accordance with a prescribed calculation method.

The operation of the thus configured detection threshold value calculation unit 7 and its component elements will be described with reference to FIG. 4 and FIGS. 5A to 5C. FIG. 4 is a general flowchart illustrating the detection threshold value calculation process performed in the detection threshold value calculation unit 7, and FIGS. 5A to 5C show the graphs generated during the detection threshold value determining process.

In step S1, the gray level difference calculated pixel by pixel by the difference detection unit 6 in FIG. 1 is input to the cumulative frequency computing unit 31 in FIG. 3. In step S2, the cumulative frequency computing unit 31 constructs a histogram of gray level differences such as shown in FIG. 5A. Here, if the number of pixels under inspection is large, the histogram need not be constructed by obtaining gray level differences for all the pixels, but is constructed by obtaining gray level differences only for selectively sampled pixels.

In step S3, the cumulative frequency computing unit 31 computes the cumulative frequency of the gray level difference based on the histogram.

In step S4, assuming that the gray level difference obeys a certain type of distribution, the converted cumulative frequency computing unit 32 converts the cumulative frequency so that the cumulative frequency shows a linear relationship to the gray level difference in the assumed distribution. Here, the converted cumulative frequency computing unit 32 converts the cumulative frequency by assuming that the gray level difference obeys a certain type of distribution such as a normal distribution, a Poisson distribution, or a chi-squared distribution. The thus converted cumulative frequency is shown in FIG. 5B.

In step S5, from the converted cumulative frequency the approximation straight line deriving unit 33 derives the approximation straight line (y=ax+b) representing the relationship between the gray level difference and the converted cumulative frequency (see FIG. 5C).

In step S6, the threshold value determining unit 34 determines the threshold value based on the parameters “a” and “b” of the approximation straight line and on sensitivity setting parameters (fixed values). Here, VOP and HO are set as the fixed sensitivity setting parameters for the approximation straight line representing the relationship between the gray level difference and the converted cumulative frequency, and the point on the straight line is obtained that represents the cumulative frequency P1 corresponding to a certain cumulative probability (p) (P1 is obtained by multiplying p by the number of samples); then, the gray level difference obtained by moving that point by VOP in the vertical axis direction and by HO in the horizontal axis direction is taken as the threshold value. Accordingly, the threshold value T is calculated by the prescribed equation
T=(P1−b+VOP)/(a+HO) (1)
In this way, the threshold value can be suitably determined automatically in accordance with a histogram of the gray level difference of the image under inspection.

### SUMMARY OF THE INVENTION

In the appearance inspection apparatus and appearance inspection method according to the prior art, only defect information concerning the defects detected as described above (i.e., the number of defects, size of defect, position of defect, kind of defect, etc.) has been output and reported to the user. However, because the detection threshold value used for defect detection is automatically changed and set for each sample (wafer) or for each die as described above, the user has been unable to determine based on the reported defect information whether each sample has the same quality or not.

That is, if the set value of the detection threshold changes greatly, and the detection threshold value used for defect detection differs widely from sample to sample, then even when the numbers of defects detected using the different threshold values for different samples are the same, there is the possibility that the different samples may have entirely different qualities.

In view of the above problem, it is an object of the present invention to provide an appearance inspection apparatus and an appearance inspection method wherein, in addition to the above-mentioned defect information, information indicating differences between images used for inspecting the appearance of samples is reported to the user, thereby making it possible to present the differences between the samples which the user has been unable to know in the prior art appearance inspection.

To achieve the above object, according to the present invention, distribution information indicating the distribution of pixel values in the captured image is computed and output in addition to the above-mentioned defect information.

That is, an appearance inspection apparatus according to a first aspect of the present invention comprises: imaging unit which captures an image of a surface of a sample; and defect detecting unit which detects a defect on the sample based on the image acquired by the imaging unit, wherein the appearance inspection apparatus further comprises: distribution information computing unit which computes distribution information indicating the distribution of pixel values in the image captured by the imaging unit; and distribution information output unit which outputs the distribution information in addition to information concerning the defect detected by the defect detecting unit.

Further, in an appearance inspection method according to a second aspect of the present invention, when detecting a defect on the sample based on the image captured from the surface of the sample, distribution information indicating the distribution of pixel values in the captured image is computed and output in addition to information concerning the detected defect.

For example, statistics on the pixel values in the captured image, image noise levels, or image noise level distribution information may be output as the distribution information. Alternatively, the difference between the pixel values of two corresponding pixels in the image may be computed, and information indicating the distribution of such differences or statistics thereof within the image may be output as the distribution information.

The appearance inspection apparatus and appearance inspection method according to the present invention may be used for inspecting the appearance of a semiconductor wafer with a plurality of dies formed on a surface thereof. In this case, distribution information indicating the distribution of the gray levels of the pixels in the image captured by the imaging unit is computed and output. Further, the gray level difference between two corresponding pixels located in different portions of the image representing different dies may be computed, and distribution information indicating the distribution of such gray level differences within the image may be computed and output.

When repeating patterns such as memory cells are formed on each die, the gray level difference between two corresponding pixels located in different portions of the image representing different cells may be computed, and distribution information indicating the distribution of such gray level differences within the image may be computed and output.

### BRIEF DESCRIPTION OF THE DRAWINGS

The present invention will be more clearly understood from the description as set below with reference to the accompanying drawings, wherein:

FIG. 1 is a block diagram showing the general configuration of an appearance inspection apparatus according to the prior art;

FIG. 2 is a diagram showing an arrangement of dies on a semiconductor wafer;

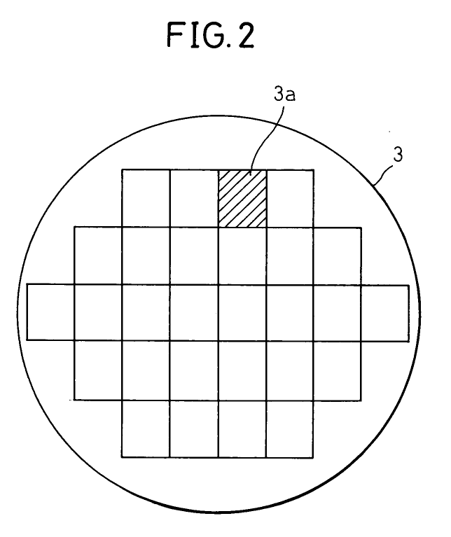

FIG. 3 is a block diagram showing a configuration example of a detection threshold value calculation unit in the appearance inspection apparatus of FIG. 1;

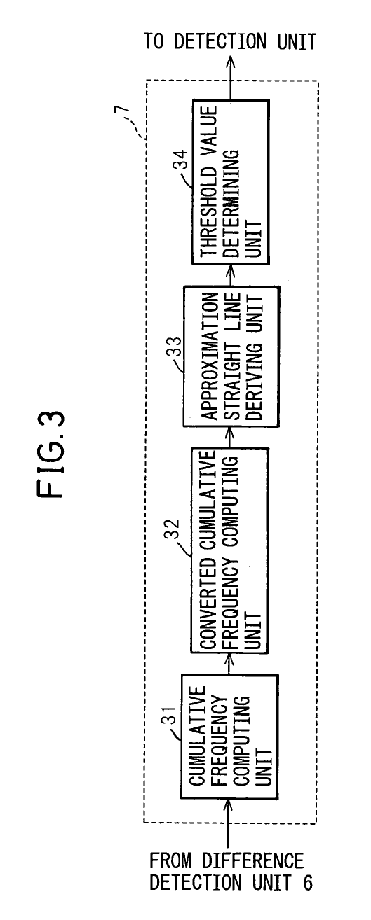

FIG. 4 is a flowchart illustrating the detection threshold value calculation process performed in the detection threshold value calculation unit of FIG. 3;

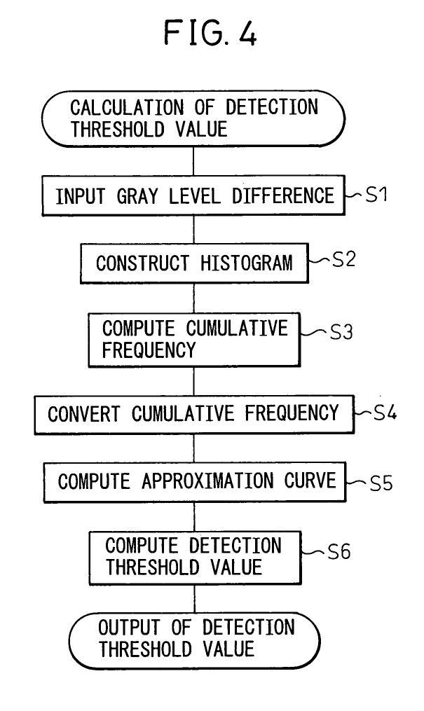

FIGS. 5A to 5C are diagrams for explaining the process for determining a threshold value;

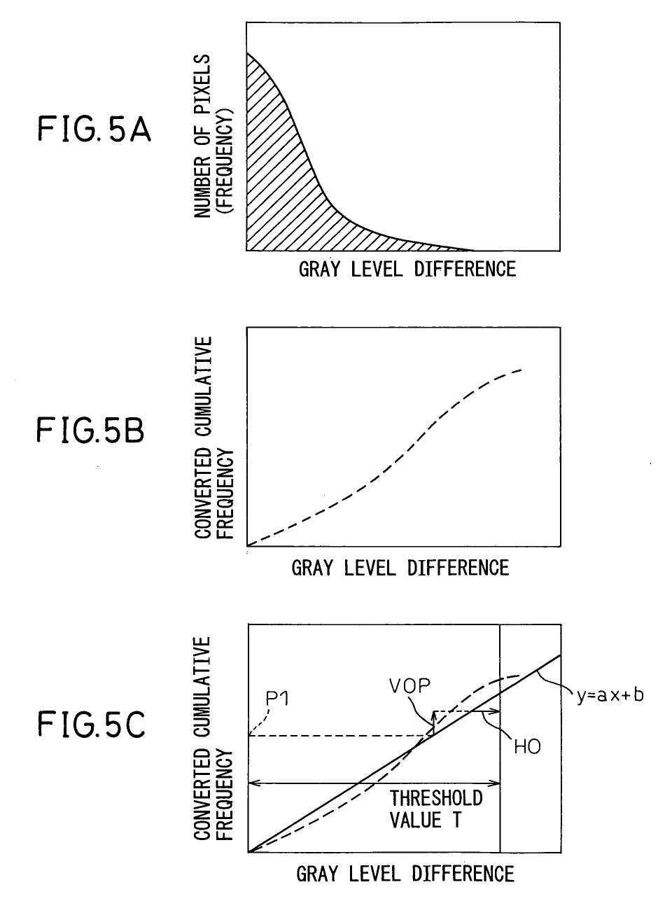

FIG. 6 is a block diagram showing the general configuration of a semiconductor pattern appearance inspection apparatus according to an embodiment of the present invention; and

FIG. 7 is a diagram showing the configuration of functional modules implemented by a distribution information computing unit shown in FIG. 6.

### DESCRIPTION OF THE PREFERRED EMBODIMENTS

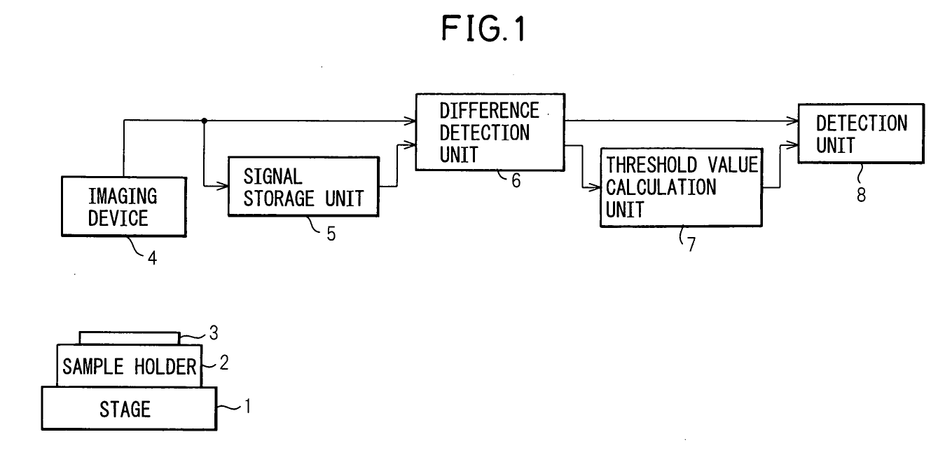

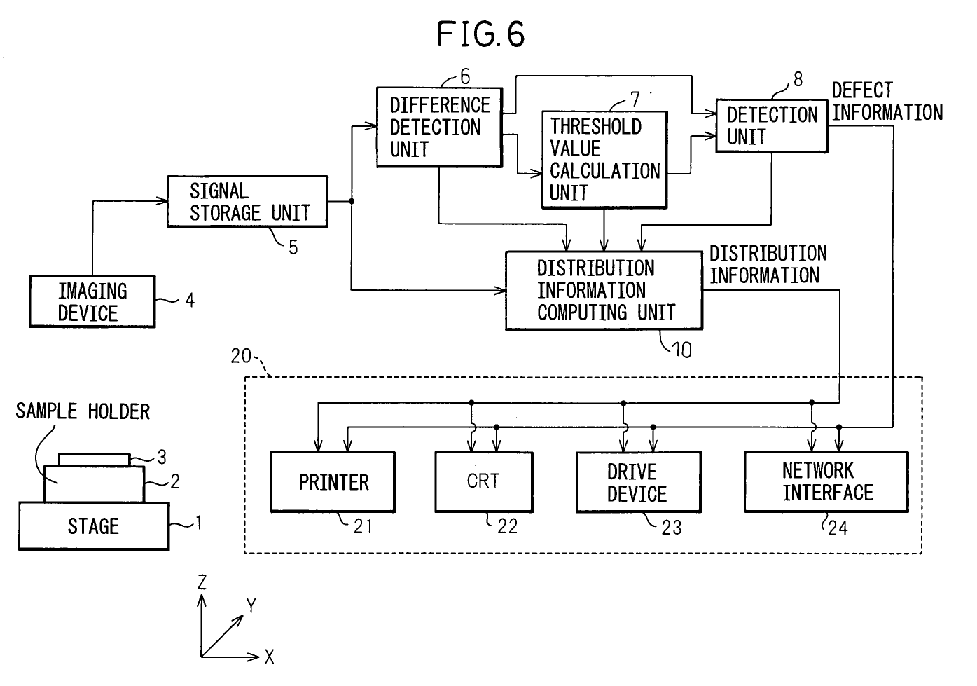

Preferred embodiments of the present invention will be described in detail below while referring to the attached figures. FIG. 6 is a block diagram showing the general configuration of a semiconductor pattern appearance inspection apparatus according to an embodiment of the present invention. The semiconductor pattern appearance inspection apparatus shown in FIG. 6 is similar in configuration to the semiconductor pattern appearance inspection apparatus described with reference to FIG. 1; therefore, the same or similar component elements are designated by the same reference numerals, and the same component elements will not be described in detail herein.

As shown, the sample holder 2 is mounted on the upper surface of the stage 1 which is movable in two- or three-dimensional directions, and the semiconductor wafer 3 to be inspected is placed and held fixed onto the sample holder 2. The imaging device 4 constructed from a CCD camera or the like is disposed above the stage, and the imaging device 4 generates an image signal by capturing an image of a pattern formed on the semiconductor wafer 3.

The imaging device 4 comprises a one-dimensional CCD camera such as a TDI, and the stage 1 is moved so that the camera moves (scans) relative to the semiconductor wafer 3 at a constant speed in the X or Y direction. The image signal is converted into a multi-valued digital signal (gray level signal), and each image signal thus converted is sequentially stored in the signal storage unit 5.

Based on the known repeating pitch for the dies formed on the wafer 3 under inspection, gray level signals representing the pixels located at corresponding positions in the images of two adjacent dies within the captured image are read out of the signal storage unit 5 and input to the difference detection unit 6. Actually, processing such as fine registration is also performed, but a detailed description of such processing will not be given here.

When the gray level signals from the two adjacent dies are input to the difference detection unit 6, the difference detection unit 6 computes the difference (gray level difference) between the two gray level signals and supplies it to the detection threshold value calculation unit 7 and the detection unit 8. The detection threshold value calculation unit 7 determines the detection threshold value based on the distribution of the gray level difference and supplies the detection threshold value to the detection unit 8. The detection unit 8 compares the gray level difference with the thus determined threshold value to determine whether or not the portion under inspection contains a defect. If a defect is detected, then the die number containing the detected defect, the position of the defect within the die, the size of the defect, the kind of the defect, etc. are supplied as defect information to an inspection result output unit 20 to be described later. Hence, the signal storage unit 5, the difference detection unit 6, the detection threshold value calculation unit 7, and the detection unit 8 together constitute the defect detecting unit according to the present invention.

The semiconductor pattern appearance inspection apparatus further includes: a distribution information computing unit 10 which reads out the image captured by the imaging device 4 and stored in the signal storage unit 5 and computes distribution information indicating the distribution of the gray level signals (pixel values) within the captured image; and the inspection result output unit 20 for outputting the defect information concerning the defect detected by the detection unit 8 and the distribution information computed by the distribution information computing unit 10.

The inspection result output unit 20 may be construction using any known data output means for outputting data from the semiconductor pattern appearance inspection apparatus. For example, as shown in FIG. 6, the inspection result output unit 20 may include a printer device 21, a display device such as a CRT 22, a drive device 23 such as a hard disk drive, a removable storage device, a CD-ROM drive device, or a DVD drive device, or an interface unit such as a network interface 24 for simply outputting data to another computer. The semiconductor pattern appearance inspection apparatus outputs via the thus constructed inspection result output unit 20 the defect information concerning the defect detected by the detection unit 8 and the distribution information computed by the distribution information computing unit 10, for presentation to the user or other computer device or the like. Hence, the inspection result output unit 20 constitutes the distribution information output unit according to the present invention.

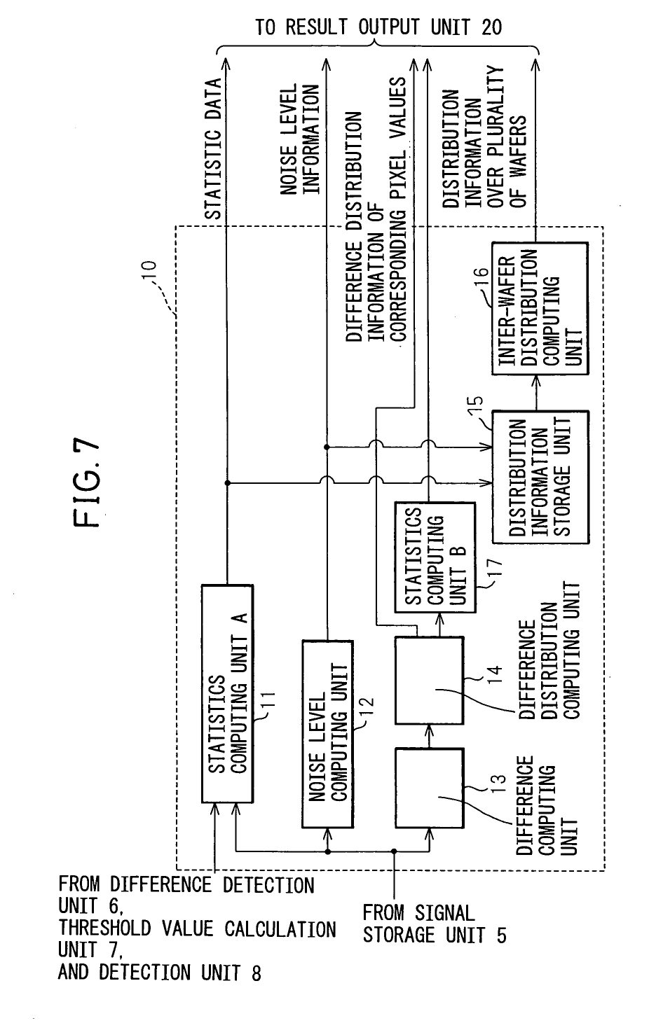

FIG. 7 is a diagram showing the configuration of functional modules implemented by the distribution information computing unit 10. The distribution information computing unit 10 implements a statistics computing unit 11 which computes, as the distribution information, various kinds of statistics about the defects detected by the detection unit 8 and about the gray level signal values representing the pixel values of the pixels contained in the image captured by the imaging device 4 and stored in the signal storage unit 5.

The distribution information computing unit 10 further implements functional modules comprising: a noise level computing unit 12 which computes, as the distribution information, the noise level of the captured image stored in the signal storage unit 5 and information indicating its distribution; a difference computing unit 13 which computes a gray level difference representing the difference between the pixel values of two corresponding pixels in the captured image; a difference distribution computing unit 14 which computes, as the distribution information, information showing the distribution of the above difference; and a statistics computing unit 17 which computes, as the distribution information, various kinds of statistics about the distribution information computed by the difference distribution computing unit 14.

Here, the difference computing unit 13 and the difference detection unit 6 shown in FIG. 6 may be implemented by the same circuit.

The distribution information computing unit 10 further includes a distribution information storage unit 15 for storing the distribution information computed by the statistics computing unit 11 and the noise level computing unit 12 for a plurality of wafers, and implements an inter-wafer distribution information analyzing unit 16 which analyzes the distribution information computed for the plurality of wafers.

The modules 11 to 14, 16 and 17 may each be implemented as a program module to be executed on hardware having a single data processing unit, or may each be constructed from a separate hardware circuit.

Next, a description will be given of the modules 11 to 14, 16 and 17 and the distribution information computed by the respective modules.

The statistics computing unit 11 computes, as the distribution information, various kinds of statistics about the gray level signal values representing the pixel values of the pixels contained in the captured image stored in the signal storage unit 5. For such statistics, the statistics computing unit 11 computes, for example, the average value, variance (standard deviation), maximum value, and minimum value of the gray level signal values of the pixels contained in the captured image.

The range of the captured image over which the statistics computing unit 11 computes the statistics may be set so as to cover the entire range of the image captured by the imaging device 4 for the defect detection, or the range may be set so that the statistics are computed only within a predetermined range on the wafer 3, for example, only within the inspection range called the care area specifically set up for the appearance inspection or only within the range of a particular die 3a.

Further, the statistics computing unit 11 may compute the statistics for each of a plurality of ranges, such as the range of each die 3a, predefined on the wafer 3 and may further compute, for these statistics, statistics such as the average value, variance (standard deviation), maximum value, and minimum value.

Further, the statistics computing unit 11 acquires defect coordinate information, etc. output from the detection unit 8, and computes the defect density and defect level.

For example, for the plurality of ranges predefined on the wafer 3, the statistics computing unit 11 may compute the number of defect pixels detected within the respective ranges predefined on the wafer 3 and compute the distribution information such as the distribution of the defect density and its average value, variance (standard deviation), maximum value, and minimum value.

Further, as the degree of clarity of the detected defect can be quantified by the difference between the gray level difference at the defect pixel location and the detection threshold value, the statistics computing unit 11 may take as inputs the gray level difference at the coordinate position of the defect detected by the detection unit 8 and the detection threshold value that the detection unit 8 used when detecting the defect, the former from the difference detection unit 6 and the latter from the detection threshold value calculation unit 7, and may compute the value (gray level difference−detection threshold) for each detected defect and integrate the value over each of the plurality of ranges predefined on the wafer 3. Then, the distribution of the integrated values thus obtained and the statistics such as the average value, variance (standard deviation), maximum value, and minimum value of the integrated values may be computed as the distribution information.

The noise level computing unit 12 computes, as the distribution information, the noise level of the captured image stored in the signal storage unit 5 and information showing its distribution.

For example, if no patterns are contained in the captured image, the noise level computing unit 12 computes as the noise level the variance (standard deviation) of the gray levels of the pixels contained in the captured image. If repeating patterns are contained in the captured image, the noise level computing unit 12 computes the absolute value of the difference between the pixel values of two corresponding pixels supposed to have like pixel values in the captured image stored in the signal storage unit 5. The absolute value of such difference may be computed for a plurality of pixels in the captured image, and the average value or variance of the absolute differences may be computed as the noise level.

For example, if the captured image stored in the signal storage unit 5 contains repeating patterns such as when the image of the wafer 3 with a plurality of dies 3a formed thereon was captured, the absolute value of the pixel value difference (gray level difference) is computed for two pixels located at positions spaced apart from each other by an integral multiple of the repeating pattern pitch. That is, the absolute value of the pixel value difference (gray level difference) is computed for pixels located at corresponding positions on two dies spaced apart from each other by an integral multiple of the repeating pitch.

The absolute value of such a difference may be computed for one or a plurality of pairs of dies 3a (for each of the pixels contained in the areas corresponding the dies 3a), and its average value may be computed as the noise level.

The range of the captured image over which the noise level computing unit 12 computes the noise level may be set so as to cover the entire range of the image captured by the imaging device 4 for the defect detection, or the range may be set so that the noise level is computed only within a predetermined range on the wafer 3, for example, only within the inspection range called the care area specifically set up for the appearance inspection or only within the range of a particular die 3a.

Further, the noise level computing unit 12 may compute the noise level for each of a plurality of ranges, such as the range of each die 3a, predefined on the wafer 3 and may further compute, for these noise levels, statistics such as the average value, variance (standard deviation), maximum value, minimum value, etc. as the distribution information.

The difference computing unit 13 computes the absolute value of the difference between the pixel values of two pixels supposed to have like pixel values in the captured image stored in the signal storage unit 5.

For example, if the captured image stored in the signal storage unit 5 contains repeating patterns such as when the image of the wafer 3 with a plurality of dies 3a formed thereon was captured, the absolute value of the pixel value difference is computed for two pixels located at positions spaced apart from each other by an integral multiple of the repeating pattern pitch. That is, the absolute value of the pixel value difference is computed for pixels located at corresponding positions on two dies spaced apart from each other by an integral multiple of the repeating pitch.

The range over which the difference computing unit 13 computes the absolute value of the pixel value difference may be set so as to cover the entire range of the image captured by the imaging device 4 for the defect detection, or the range may be set so as to cover only a predetermined range on the wafer 3 such as the inspection range called the care area specifically set up for the appearance inspection.

Further, when the captured image includes an image captured from the wafer 3 with a plurality of dies 3a formed thereon, the difference computing unit 13 may compute the absolute value of the pixel value difference between pixels located at corresponding positions within each pair of dies 3a (for example, adjacent dies) over the areas corresponding the paired dies 3a (for each pixel contained in these areas).

Alternatively, the difference computing unit 13 may compute the absolute value of the pixel value difference between pixels located at corresponding positions within each pair of dies 3a over the entire areas corresponding a plurality of pairs of dies 3a. For example, for all the dies 3a formed on the wafer 3, the difference computing unit 13 may compute the absolute value of the pixel value difference between pixels located at corresponding positions within each pair of adjacent dies. Instead, it may be computed only for each pair of adjacent dies located within a predetermined range on the wafer 3.

The difference distribution computing unit 14 computes the information indicating the distribution of the absolute values of the pixel value differences (gray level differences) computed by the difference computing unit 13. For such information, the difference distribution computing unit 14 computes statistics such as the average value, variance (standard deviation), maximum value, and minimum value of the absolute values.

Here, the difference distribution computing unit 14 may compute the statistics of the absolute values for each of a plurality of ranges, such as the range of each die 3a, predefined on the wafer 3, and the statistics computing unit 17 may further compute, for these statistics, statistics such as the average value, variance (standard deviation), maximum value, and minimum value as the distribution information for output.

Further, the difference computing unit 13 may compute a signed value representing the difference (gray level difference) between each pair of pixel values, and the difference distribution computing unit 14 may compute statistics such as the average value, variance (standard deviation), maximum value, and minimum value of the signed difference values. In particular, the average value of the signed difference values serves as the distribution information that indicates lightness non-uniformity (color variation).

Further, when repeating patterns such as memory cells (not shown) are formed on the die 3a, the absolute value of the pixel value difference between pixels located at corresponding positions within each pair of cells may be computed over the entire areas corresponding a plurality of cells. For example, for all the cells formed on each die 3a on the wafer 3, the difference computing unit 13 may compute the absolute value of the pixel value difference between pixels located at corresponding positions on each pair of adjacent cells. Instead, it may be computed only for each pair of adjacent cells located within a predetermined range on the die 3a. Alternatively, it may be computed for every die formed on the wafer 3 or only for a particular die 3a formed on the wafer 3.

Then, the difference distribution computing unit 14 computes the information indicating the distribution of the absolute values of the pixel value differences (gray level differences) computed for the pairs of corresponding cells by the difference computing unit 13. Examples of such information include the average value, variance (standard deviation), maximum value, minimum value, etc. of the absolute values of the cell comparison gray level differences, taken for each die 3a.

Further, for these statistics, the statistics computing unit 17 may compute statistics (average value, variance (standard deviation), maximum value, minimum value, etc.) over a plurality of dies 3a and output them as the distribution information. The distribution information computed by the statistics computing unit 11 and the noise level computing unit 12 or by the difference computing unit 13, the difference distribution computing unit 14, and the statistics computing unit 17 is sent to the inspection result output unit 20. The inspection result output unit 20 outputs the distribution information in addition to or instead of the defect information concerning the defects detected by the detection unit 8.

The distribution information storage unit 15 stores the distribution information computed by the statistics computing unit 11 and the noise level computing unit 12 for a plurality of samples (for example, wafers 3). Based on the distribution information computed for the plurality of wafers 3, the inter-wafer distribution information analyzing unit 16 computes evaluation information for these wafers 3. Alternatively, the inter-wafer distribution information analyzing unit 16 may further compute statistic data, for example, for the statistics such as the average value, etc. computed for the plurality of wafers 3.

For example, using the noise level average value computed for each wafer 3, the inter-wafer distribution information analyzing unit 16 may compute evaluation information concerning the relative evaluation of the wafer 3 as a measure of evaluating the quality of the wafer 3.

The above embodiment has been described by taking as an example the case where the image captured by the imaging device 4 is a gray scale image; however, when the image captured by the imaging device 4 is a color image, the distribution information computing section 10 may compute the distribution information indicating the distribution of pixels values, such as the lightness, saturation, hue, brightness, and/or color difference of each pixel in the captured image, and/or the distribution of the difference values between these pixel values, instead of the distribution information for the gray levels, i.e., the pixel values and/or the gray level differences in the gray scale image.

According to the present invention, it becomes possible to present the user with information indicating the differences between images used for the appearance inspection of samples. This makes it possible to present the differences between different samples which the user has been unable to know in the prior art appearance inspection, and thus the appearance inspection can be performed with increased sensitivity.

The present invention is applicable to an appearance inspection apparatus which captures an image of a surface of a sample and inspects the appearance of the sample based on the captured image; in particularly, the invention can be applied advantageously to an appearance inspection apparatus for detecting defects on a liquid crystal display panel or in semiconductor circuit patterns formed on a semiconductor wafer during a semiconductor fabrication process.

While the invention has been described with reference to specific embodiments chosen for purpose of illustration, it should be apparent that numerous modifications could be made thereto by those skilled in the art without departing from the basic concept and scope of the invention.

1. An appearance inspection apparatus comprising: an imaging unit which captures an image of a surface of a sample; and a defect detecting unit which detects a defect on said sample based on said image acquired by said imaging unit, wherein said appearance inspection apparatus further comprises:
a distribution information computing unit which computes distribution information indicating the distribution of pixel values in said image captured by said imaging unit; and
a distribution information output unit which outputs said distribution information in addition to information concerning said defect detected by said defect detecting unit.

2. An appearance inspection apparatus as claimed in claim 1, wherein said distribution information computing unit includes a statistics computing unit which computes statistics about said pixel values as said distribution information.

3. An appearance inspection apparatus as claimed in claim 1, wherein said distribution information computing unit includes a noise level computing unit which computes a noise level for said image as said distribution information.

4. An appearance inspection apparatus as claimed in claim 1, wherein said distribution information computing unit includes a noise level computing unit which computes noise level distribution information for said image as said distribution information.

5. An appearance inspection apparatus as claimed in claim 1, wherein said distribution information computing unit includes:
a difference computing unit which computes a difference between the pixel values of two corresponding pixels in said image; and
a difference distribution computing unit which computes, as said distribution information, distribution information indicating the distribution of said difference within said image.

6. An appearance inspection apparatus as claimed in claim 1, wherein said sample is a semiconductor wafer, and said pixel values represent gray levels of pixels contained in said image captured by said imaging unit.

7. An appearance inspection apparatus as claimed in claim 5, wherein
said sample is a semiconductor wafer with a plurality of dies formed on a surface thereof,
said difference computing unit computes a gray level difference between two corresponding pixels located in different portions of said image representing different dies taken from among said plurality of dies, and
said difference distribution computing unit computes, as said distribution information, distribution information indicating the distribution of said gray level difference within said image.

8. An appearance inspection apparatus as claimed in claim 5, wherein
said sample is a semiconductor wafer with a plurality of dies formed on a surface thereof,
repeating patterns of a plurality of cells are formed on each of said dies,
said difference computing unit computes a gray level difference between two corresponding pixels located in different portions of said image representing different cells taken from among said plurality of cells, and
said difference distribution computing unit computes, as said distribution information, distribution information indicating the distribution of said gray level difference within said image.

9. An appearance inspection method for detecting a defect on a sample based on an image captured from a surface of said sample, wherein in addition to information concerning said detected defect, information indicating the distribution of pixel values in said captured image is computed and output.

10. An appearance inspection method as claimed in claim 9, wherein statistics about said pixel values are computed and output as said distribution information.

11. An appearance inspection method as claimed in claim 9, wherein a noise level for said image is computed and output as said distribution information.

12. An appearance inspection method as claimed in claim 9, wherein said sample is a semiconductor wafer, and said pixel values represent gray levels of pixels contained in said captured image.
